(19) United States
(12) Patent Application Publication
(10) Pub. No.: US 2005/0138355 A1
(43) Pub. Date: Jun. 23, 2005

(54) System, method and devices for authentication in a wireless local area network (WLAN)

(76) Inventors: Lidong Chen, Palatine, IL (US); Rajesh S. Pazhyannur, Lake Zurich, IL (US)

Correspondence Address: MOTOROLA INC, 600 NORTH US HIGHWAY 45, ROOM AS437, LIBERTYVILLE, IL, 60048-5343, US

(21) Appl. No.: 10/741,408

(22) Filed: Dec. 19, 2003

(51) Int. Cl. H04L 9/00

(52) U.S. Cl. 713/155

(57) ABSTRACT

A system (100) for authentication in a wireless local area network (WLAN) includes a CDMA2000 authentication center (190) for authenticating CDMA2000 credentials (110), a WLAN authentication server (150) for using the CDMA2000 credentials to authenticate WLAN devices holding CDMA2000 credentials, and at least one WLAN device (130) holding CDMA2000 credentials. The WLAN server (150) performs a CDMA2000 global challenge and response (213) and a CDMA2000 unique challenge and response (223) with a WLAN device to obtain a CDMA2000 encryption key (233). The WLAN server (150) derives a master key from the CDMA2000 encryption key (234) and uses the master key to perform a WLAN challenge and response (237) with the WLAN device (130) and then derives session keys from the master key (240). The session keys protect communications between the WLAN access point (140) and the WLAN device (130).

### FIELD OF THE DISCLOSURE

This disclosure relates generally to wireless local area network (WLAN) authentication, and more specifically to reusing CDMA2000 credentials to authenticate WLAN devices.

### BACKGROUND OF THE DISCLOSURE

Global System for Mobile Communications (GSM) manufacturers and operators have put tremendous efforts into finding solutions for using GSM credentials to authenticate WLAN devices. One solution proposed in standards bodies, like the Internet Engineering Task Force (IETF) and the Third Generation Partnership Project (3GPP), uses an Extensible Authentication Protocol (EAP) mechanism for authentication and session key distribution using the GSM Subscriber Identity Module (SIM).

Due to differences in the subscriber unit authentication processes for GSM and CDMA2000 networks, the EAP/SIM mechanism cannot be applied to using CDMA2000 credentials to authenticate WLAN devices. The main difficulty is that, in CDMA2000 networks, the home location register authentication center (HLR/AC) is more involved in the steps of the authentication process. CDMA2000 HLR/AC participation is even more pronounced when a second level of key, called shared secret data (SSD), is not shared with a CDMA2000 serving network in accordance with a CDMA2000 network operator's policy. No authentication vectors (triplets), such as those available in GSM, can be provided to a CDMA2000 serving network to derive WLAN security parameters. Additionally, the CDMA2000 and WLAN authentication processes use different functions to generate keys, different packet and frame structures, and different encryption methodologies.

There is a desire to provide a method for using CDMA2000 credentials to authenticate WLAN devices. There is also a desire to minimize disruption of existing authentication processes for CDMA2000 networks and for WLAN networks while reusing the CDMA2000 credentials. There is a desire to avoid greatly increasing network traffic when using CDMA2000 credentials to authenticate WLAN devices.

The various aspects, features and advantages of the disclosure will become more fully apparent to those having ordinary skill in the art upon careful consideration of the following Drawings and accompanying Detailed Description.

### BRIEF DESCRIPTION OF THE DRAWINGS

FIG. 1 is a functional block diagram of a system that uses CDMA2000 credentials for authentication of a CDMA2000 wireless communication device and also for authentication of a WLAN wireless communication device.

FIG. 2 is a flowchart showing a WLAN device authentication process in a WLAN network according to a preferred embodiment.

FIG. 3 is a flowchart showing details of performing and verifying a CDMA2000 global challenge and response according to the preferred embodiment of the WLAN device authentication process shown in FIG. 2.

FIG. 4 is a flowchart showing details of performing and verifying a CDMA2000 unique challenge and response according to the preferred embodiment of the WLAN device authentication process shown in FIG. 2.

FIG. 5 is a flowchart showing details of deriving and using a WLAN master key according to the preferred embodiment of the WLAN device authentication process shown in FIG. 2.

FIG. 6 is a flowchart showing details of WLAN network authentication of a WLAN device using a derived WLAN master key.

FIG. 7 is a flowchart showing a WLAN device authentication process in a WLAN device according to a preferred embodiment.

FIG. 8 is a functional block diagram of a WLAN device 800 according to a preferred embodiment.

FIG. 9 is a flowchart showing a process for converting CDMA2000 authentication protocol to a new extension of Extensible Authentication Protocol (EAP), called EAP/CDMA2000.

FIG. 10 is a flowchart showing a process for a shared secret data (SSD) update, with a WLAN server converting an SSD update protocol to a new extension of Extensible Authentication Protocol (EAP), called EAP/CDMA2000.

### DETAILED DESCRIPTION OF THE PREFERRED EMBODIMENTS

A system for authentication in a wireless local area network (WLAN) includes a CDMA2000 authentication center for authenticating CDMA2000 credentials, a WLAN authentication server coupled to the cellular authentication center for using the CDMA2000 credentials to authenticate WLAN devices holding CDMA2000 credentials, and at least one WLAN device holding CDMA2000 credentials coupled to the WLAN authentication server. The WLAN server performs a CDMA2000 global challenge and response as well as a CDMA2000 unique challenge and response with a WLAN device holding CDMA2000 credentials in order to obtain a CDMA2000 encryption key. The WLAN server derives a master key from the CDMA2000 encryption key and uses the master key to perform a WLAN challenge and response with the WLAN device. If the WLAN challenge and response is successful, the WLAN server derives session keys from the master key and delivers the session keys to a WLAN access point to protect communications between the WLAN access point and the WLAN device.

The WLAN server uses an extension of Extensible Authentication Protocol (EAP) to facilitate communications between the CDMA2000 authentication center and a WLAN device. The WLAN device has a wireless transceiver and includes a CDMA2000 user identifier module (UIM) for storing CDMA2000 credentials and generating a CDMA2000 encryption key, a random number generator coupled to a transceiver, WLAN authentication module, and session key derivation module for generating a random challenge, a master key generation module coupled to the UIM for deriving a WLAN master key from the CDMA2000 encryption key, a WLAN authentication module coupled to the master key generation module and the wireless transceiver for responding to a challenge from a WLAN server, a session key derivation module coupled to the WLAN authentication module and the master key generation module to derive session keys from the master key, and a communication protection module coupled to the session key derivation module and the wireless transceiver to apply protection to WLAN data using the session keys.

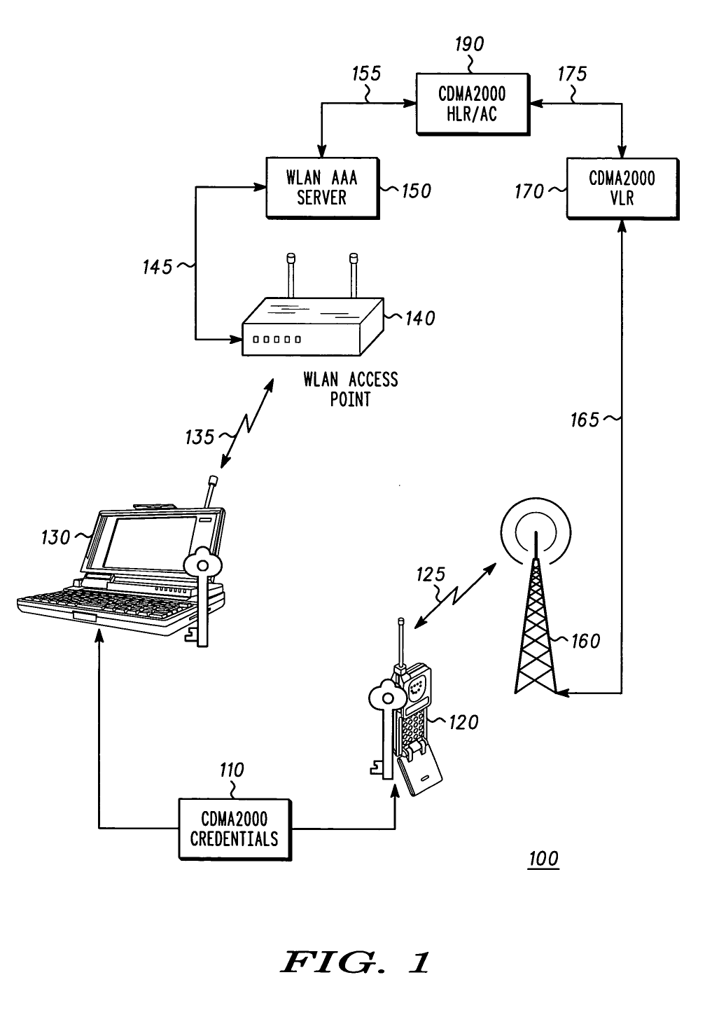

FIG. 1 is a functional block diagram of a system 100 that uses CDMA2000 credentials 110 for authentication of a CDMA2000 wireless communication device 120 and also for authentication of a WLAN wireless communication device 130. Each CDMA2000 subscriber unit 120, such as a cellular telephone or personal digital assistant with wireless CDMA2000 transceiver, makes use of a User Identity Module (UIM) that contains CDMA2000 credentials 110. (When it is removable, then it is called a Removable UIM (R-UIM), but we will not distinguish here between UIM and R-UIM and instead focus on its function.) These CDMA2000 credentials 110 are used by the CDMA2000 wireless communication device 120 when communicating through a wireless connection 125 to a CDMA2000 base station 160. Preferably, the wireless connection 125 uses the CDMA2000 air interface protocol, which is backwards compatible with ANSI-95. If the base station 160 communicates through connection 165 with a CDMA2000 visitor location register (VLR) 170 using a protocol such as CDMA2000 A, the VLR will query a CDMA2000 home location register authentication center (HLR/AC) 190 over communication connection 175 during the process of authenticating the wireless communication device 120. The communication connection 175 preferably uses ANSI-41 protocols.

A WLAN subscriber unit 130, such as a laptop or personal digital assistant with WLAN transceiver, uses the same CDMA2000 credentials 110 used to authenticate the CDMA2000 subscriber device 120. These CDMA2000 credentials 110 are used by the WLAN wireless communication device 130 when communicating through wireless connection 135 to a WLAN access point 140. Preferably, the wireless connection 135 uses an IEEE Wireless protocol, such as IEEE 802.11. The WLAN access point 140 is connected to a WLAN Authentication (AAA) server 150 through communication connection 145, which preferably uses a Wired Network protocol. The WLAN AAA server 150 uses a communication connection 155 to verify the CDMA2000 credentials of the WLAN wireless communication device 130 with the CDMA2000 HLR/AC 190. The communication connection 155 preferably uses ANSI-41 protocols.

A benefit of using the same CDMA2000 credentials 110 to authenticate both CDMA2000 access and WLAN access is that a network operator can more easily integrate WLAN services into existing CDMA2000 infrastructure. A user of CDMA2000 and WLAN services can receive a uniform bill for both the CDMA2000 and the WLAN services.

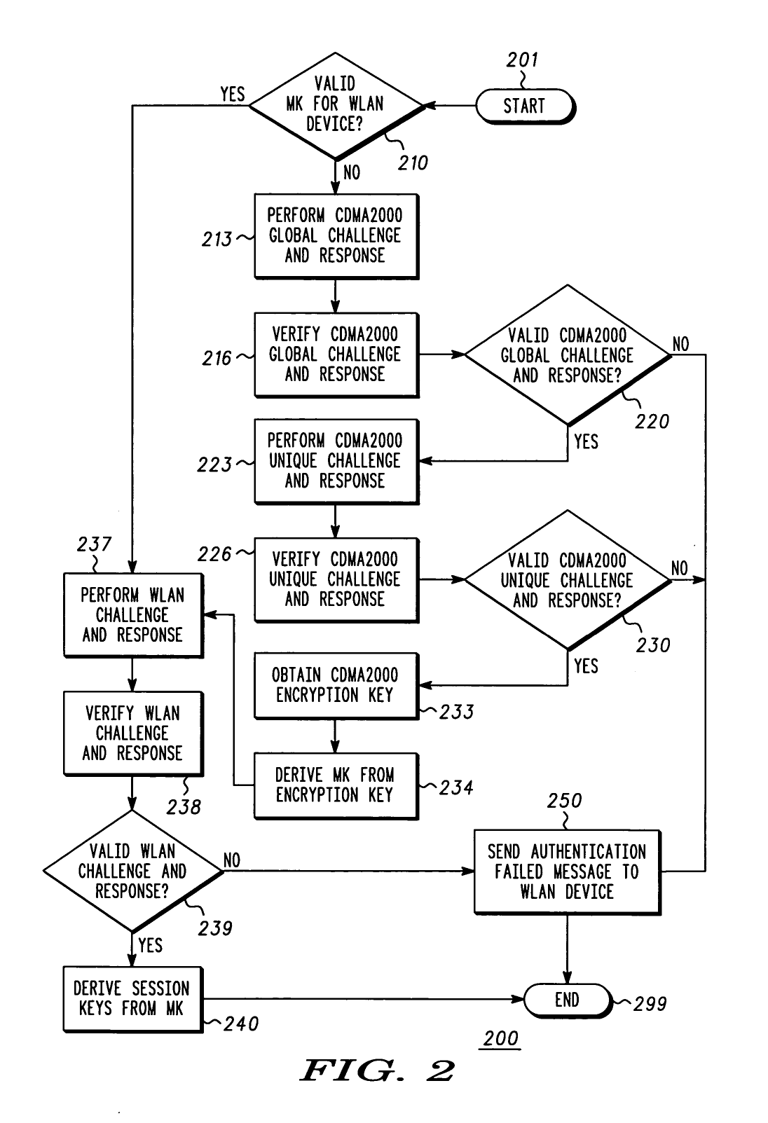

FIG. 2 is a flowchart 200 showing a WLAN device authentication process in a WLAN network according to a preferred embodiment. This authentication process uses CDMA2000 credentials, such as CDMA2000 credentials 110 shown in FIG. 1, to verify a WLAN device, such as the WLAN subscriber unit 130 shown in FIG. 1. Additionally, the WLAN device verifies the WLAN network. The authentication process preferably is implemented as a network protocol with a WLAN server such as the WLAN AAA server 150 shown in FIG. 1.

Step 201 starts the WLAN device authentication process at the WLAN network. The start step 201 can be initiated by receiving an access request from a WLAN device. Preferably, the access request includes an identifier of the WLAN device, a WLAN subscription identifier (W-ID), and a 128 bit random number RANDreq. The RANDreq is a random challenge to the WLAN network that will be used to verify the WLAN network after a valid master key is confirmed for the WLAN device. Other information, such as a CDMA2000 subscription identity (M-ID) may also be included in the access request from a WLAN device. Additionally, the start step 201 can be initiated by the WLAN network re-authenticating a WLAN device already on the WLAN network. Generally, a WLAN network will re-authenticate WLAN devices periodically as determined by the network operator. Re-authentication triggers can depend on the passage of time, a request or requirement to update the master or session key(s), CDMA2000 authentication center-triggered SSD update, as well as dynamic network conditions such as network traffic and available bandwidth.

Step 210 checks whether a valid master key already exists for authenticating the WLAN device. A valid master key implies that there is a master key stored in the WLAN server for the device and the server considers the key as being properly up-to-date. If a valid master key exists, the WLAN device is authenticated through steps 237, 238, 239, and 240, and the process ends in step 299. Details regarding the authentication steps are below. If a valid master key already exists, there is no need for the WLAN network to communicate with a CDMA2000 authentication center, which results in no negative impact on network traffic. A valid master key may already exist because, for example, the WLAN device has recently been authenticated. For instance, if a recently authenticated WLAN device detached from the WLAN network and soon reattached to the WLAN network, the authentication process would start in step 201 but the master key would still be valid for that WLAN device. Another situation where there may be a pre-existing valid master key is when the device has no CDMA2000 subscription but only a WLAN subscription. In this case, the master key is the only key for WLAN authentication. It can be installed at the time of subscription activation.

If no valid master key exists, the WLAN network will perform a CDMA2000 global challenge and response with the WLAN device in step 213. A valid master key may not exist because, for example, the WLAN device has not previously been authenticated with the WLAN network, or because the master key has been invalidated or expired.

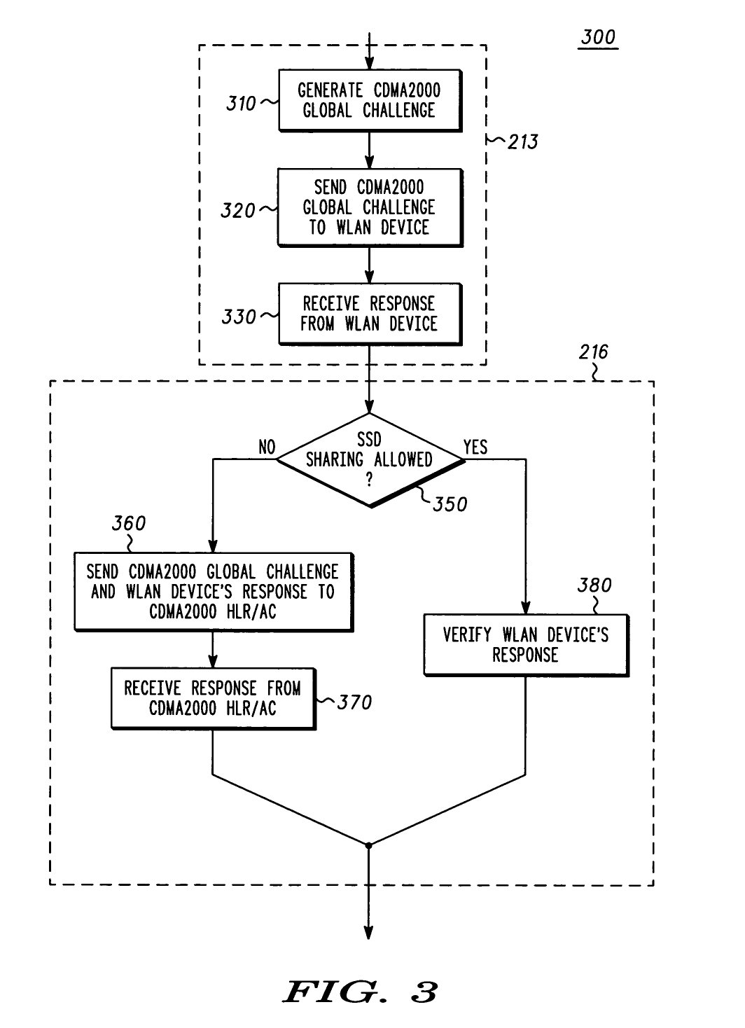

Step 216 verifies the CDMA2000 global challenge and response between the WLAN device and the WLAN network. Details regarding step 216, which depend on whether SSD is shared or not shared with the WLAN serving network, are shown in FIG. 3. If the CDMA2000 global challenge and response are not validated in step 220, the WLAN network sends an “authentication failed” message to the WLAN device in step 250 and the authentication process ends in step 299. If the CDMA2000 global challenge and response are valid in step 220, the WLAN network will perform a CDMA2000 unique challenge and response with the WLAN device in step 223.

Step 226 verifies the CDMA2000 unique challenge and response between the WLAN device and the WLAN network. If the response to the CDMA2000 unique challenge is not valid in step 230, the WLAN network sends an “authentication failed” message to the WLAN device in step 250 and the authentication process ends in step 299. If step 230 determines that the CDMA2000 unique challenge and response are valid, the WLAN network obtains a CDMA2000 encryption key in step 233.

Depending on the configuration of the CDMA2000 authentication center, the WLAN network may receive the CDMA2000 encryption key from the CDMA2000 authentication center or the WLAN network may generate the CDMA2000 encryption key. Preferably, the CDMA2000 encryption key is a signal encryption key (SMEKEY) that is conventionally generated by a CDMA2000 network for signal encryption. In this embodiment, however, the SMEKEY is re-deployed for use as WLAN key material for generating a master key.

If SSD sharing is allowed with the WLAN network, the WLAN network generates a CDMA2000 encryption key from a shared 64-bit SSD-B key for the WLAN device. Otherwise, if SSD sharing is not allowed with the WLAN network, the WLAN network receives a CDMA2000 encryption key from the CDMA2000 authentication center. Preferably, the CDMA2000 authentication center automatically generates and sends the encryption key upon successful validation of the WLAN device's response to the CDMA2000 unique challenge in step 226 and step 230.

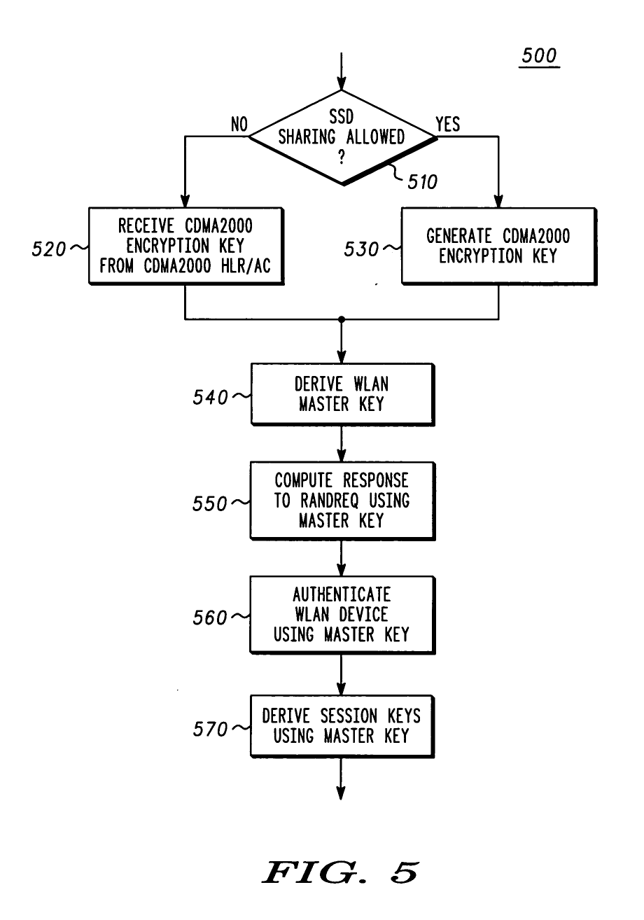

In step 234, the WLAN network derives a master key from the CDMA2000 encryption key for use when communicating with the WLAN device. In FIG. 5, step 540 and the accompanying text describe details of deriving the master key.

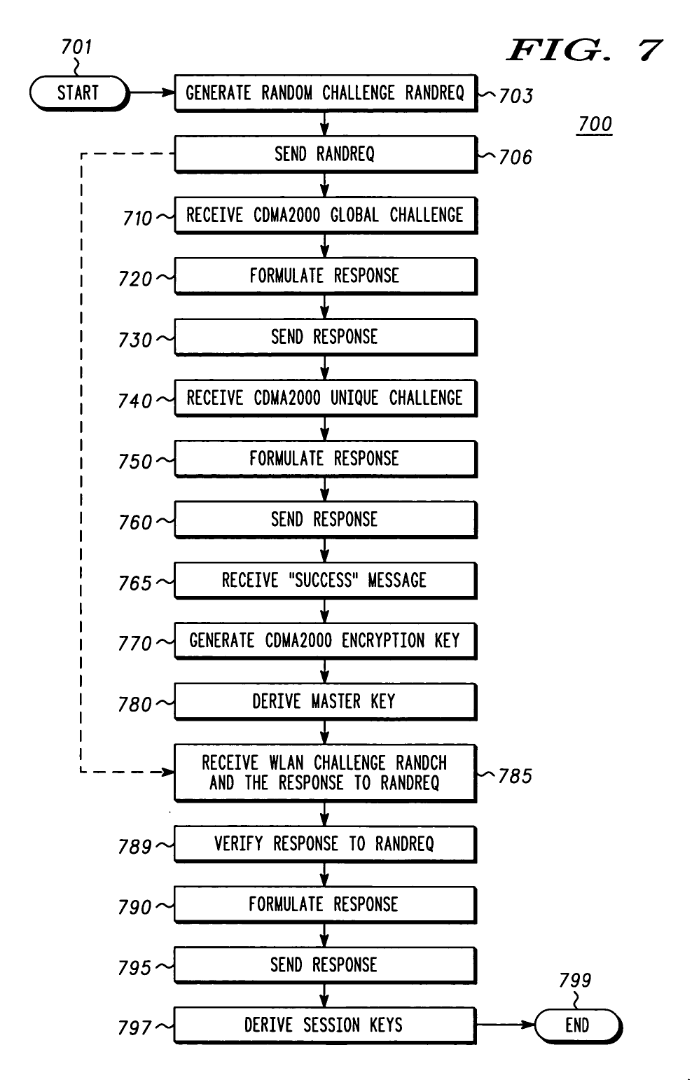

Meanwhile, the UIM in the WLAN device also generates a CDMA2000 encryption key. The WLAN device derives a master key from the encryption key using the same methodology as described for the WLAN network master key. See FIG. 7 and accompanying text. Now both the WLAN device and the WLAN network hold a master key derived from the same CDMA encryption key (SMEKEY).

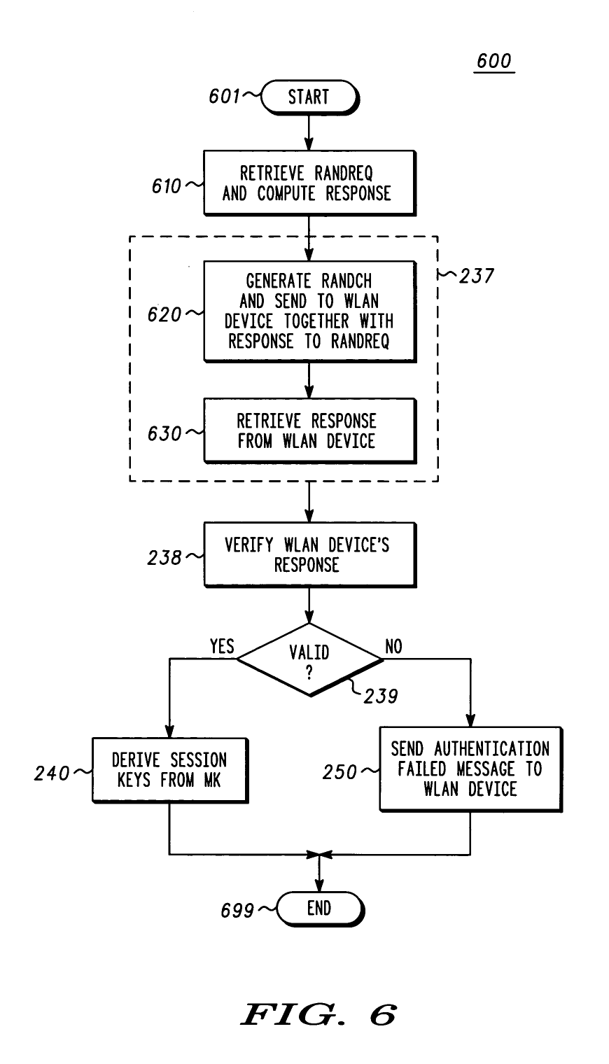

With a master key, the WLAN network can compute a response to the random challenge RANDreq received in step 201. FIG. 5 and the accompanying text describe details of computing a response to the random challenge RANDreq. In step 237, the WLAN network and the WLAN device perform a WLAN challenge and response authentication. FIG. 6 provides more detail regarding the WLAN challenge and response authentication in step 237. The WLAN network verifies the response from the WLAN device by using the master key in step 238. An invalid response as determined in step 239 will lead to sending an “authentication failed” message to the WLAN device in step 250 and the end of the protocol in step 299. A valid response as determined in step 239 implies a successful authentication and will lead to step 240.

In step 240, the WLAN network uses its master key to derive session keys. In FIG. 5, step 570 and the related text describe details of deriving session keys. Once the session keys are generated, the WLAN device authentication process is successful and ends in step 299. Once the session keys are generated, they are used to protect communications between the WLAN access point and the WLAN device. Thus, the process shown in FIG. 2 enables the generation of a valid master key which in turn is used to perform WLAN authentication without the need for the WLAN server to communicate with the CDMA2000 authentication center. See also FIG. 6 and accompanying text, which details the WLAN authentication process.

The WLAN device can be authenticated by a WLAN master key without communicating with a CDMA2000 HLR/AC such that adding WLAN service would not increase network traffic significantly. If a CDMA2000 authentication center allows sharing of shared secret data (SSD) with the WLAN network, network traffic can be reduced further. Otherwise, the WLAN network will need to communicate with the CDMA2000 authentication center when generating or updating a WLAN master key.

FIG. 3 is a flowchart 300 showing details of performing and verifying a CDMA2000 global challenge and response according to the preferred embodiment of the WLAN device authentication process shown in FIG. 2. Essentially, the flowchart 300 provides details for step 213 and step 216 shown in FIG. 2.

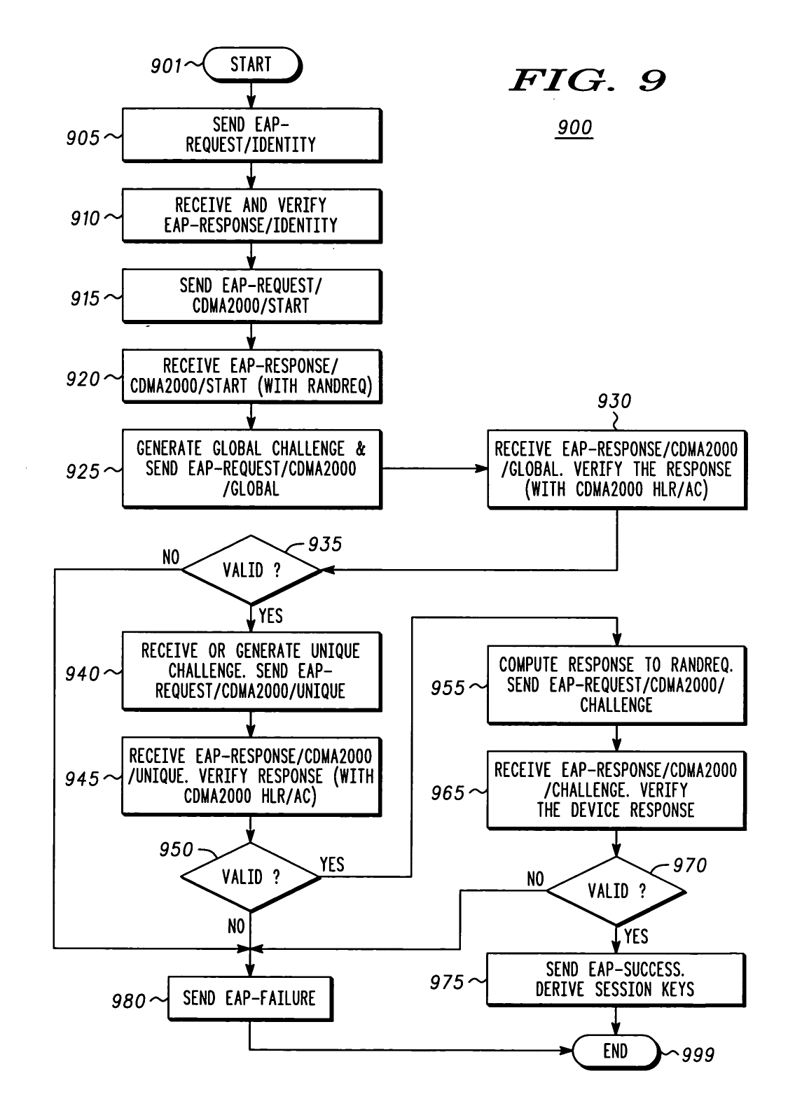

Step 310 generates a CDMA2000 global challenge. Next, step 320 sends the CDMA2000 global challenge to the WLAN device. Preferably, the WLAN network formats the CDMA2000 global challenge according to an EAP/CDMA2000 protocol, which is a CDMA2000 extension of the EAP protocol. See FIG. 9 and accompanying text for more detail regarding the EAP/CDMA2000 protocol. In step 330, the WLAN network receives from the WLAN device a response to the CDMA2000 global challenge. Steps 310, 320, and 330 form details of step 213 shown in FIG. 2.

Next, step 350 determines whether SSD sharing is allowed with the WLAN network. If SSD is not shared, the WLAN network sends the CDMA2000 global challenge and the WLAN device's response to the appropriate CDMA2000 authentication center along with the WLAN device's CDMA2000 subscription identity (M-ID) in step 360. Preferably, communications between the WLAN network and the CDMA2000 authentication center are formatted according to the ANSI-41 protocol. The WLAN network then receives a response from the CDMA authentication center in step 370, which indicates whether the CDMA2000 global challenge and response were valid.

If step 350 determines that a CDMA2000 authentication center allows sharing of SSD with the WLAN network, then in step 380, the WLAN network will verify the WLAN device's response to the CDMA2000 global challenge without interacting with the CDMA2000 authentication center. SSD sharing enables verification of the CDMA2000 global challenge and response with less network traffic than a non-shared SSD situation. Steps 350, 360, 370, and 380 form details of step 216 shown in FIG. 2.

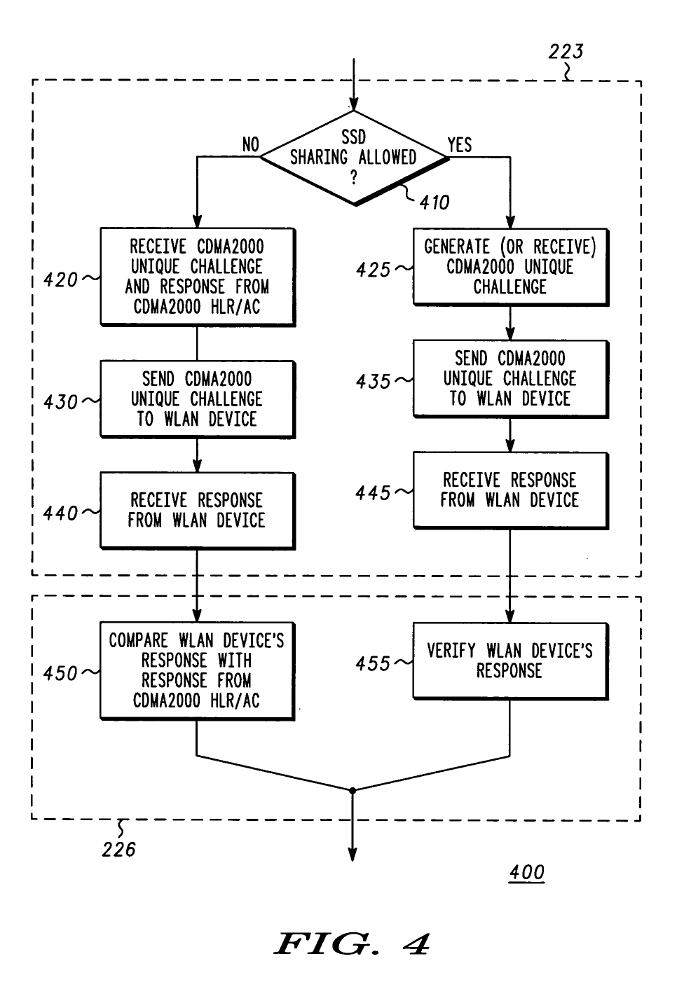

FIG. 4 is a flowchart 400 showing details of performing and verifying a CDMA2000 unique challenge and response according to the preferred embodiment of the WLAN device authentication process shown in FIG. 2. Essentially, the flowchart 400 provides details for step 223 and step 226 shown in FIG. 2. Note that the CDMA2000 authentication center may initiate a CDMA2000 unique challenge even though SSD is shared with the serving network. In this case, the WLAN serving network will perform a unique challenge to comply with CDMA2000 network authentication requirements.

Step 410 determines whether SSD sharing is allowed with the WLAN network. If SSD sharing is not allowed with the WLAN network, the WLAN network receives a CDMA2000 unique challenge together with its response from the CDMA2000 authentication center in step 420. Preferably, the CDMA2000 authentication center automatically sends the CDMA2000 unique challenge and response after it has validated the CDMA2000 global challenge and response. The CDMA2000 unique challenge and response from the CDMA2000 authentication center is preferably formatted according to the ANSI-41 protocol.

The WLAN server then sends the CDMA2000 unique challenge to the WLAN device in step 430. Preferably, the WLAN network reformats the CDMA2000 unique challenge according to the EAP/CDMA2000 protocol before communicating the CDMA2000 unique challenge to the WLAN device. Then, in step 440, the WLAN network receives a response to the CDMA2000 unique challenge from the WLAN device. Steps 410, 420, 430, and 440 are included in step 223 shown in FIG. 2.

Next, in step 450 the WLAN server verifies the WLAN device's response to the CDMA2000 unique challenge by comparing it with the one received from CDMA2000 authentication center in step 420. Step 450 is included in step 226 shown in FIG. 2.

If SSD sharing is allowed with the WLAN network as determined by step 410, the WLAN network generates a CDMA2000 unique challenge in step 425. Preferably, the WLAN network automatically generates the CDMA2000 unique challenge after it has validated the CDMA2000 global challenge and response. In a situation where a CDMA2000 home network initiates a CDMA2000 unique challenge, the WLAN network receives the CDMA2000 unique challenge from the CDMA2000 authentication center instead of generating a CDMA2000 unique challenge in step 425. Note that the unique challenge from the CDMA2000 authentication center is preferably formatted according to the ANSI-41 protocol.

The WLAN server then sends the CDMA2000 unique challenge to the WLAN device in step 435. Preferably, the WLAN network formats the CDMA2000 unique challenge according to the EAP/CDMA2000 protocol before communicating the CDMA2000 unique challenge to the WLAN device. Then, in step 445, the WLAN network receives a response to the CDMA2000 unique challenge from the WLAN device. Steps 425, 435, and 445 are also included in step 223 shown in FIG. 2.

Next, the WLAN server verifies the WLAN device's response to the CDMA2000 unique challenge in step 455. Preferably, the response is reformatted to comply with the ANSI-41 protocol. Because SSD is shared, in step 455 the WLAN server computes a response and then compares it with the response received from the WLAN device.

FIG. 5 is a flowchart 500 showing details of deriving and using a WLAN to master key according to the preferred embodiment of the WLAN device authentication process shown in FIG. 2. Essentially, the flowchart 500 provides details to use a CDMA2000 encryption key to derive a master key in step 234, to authenticate the WLAN device in steps 237, 238, and 239, and to derive session keys in step 240. The flowchart also includes an authentication of the WLAN network to a WLAN device. A challenge RANDreq is received in step 201 implicitly. The WLAN server uses the master key to compute a response to RANDreq implicitly included in step 237.

Step 510 determines whether SSD sharing is allowed. If SSD sharing is not allowed, then in step 520, the WLAN server obtains a CDMA encryption key from the CDMA2000 authentication center. If SSD sharing is allowed, then the WLAN server generates a CDMA2000 encryption key in step 530.

Upon either obtaining, in step 520, or generating, in step 530, a CDMA2000 encryption key, the WLAN server will derive a WLAN master key in step 540. Preferably, the WLAN network derives a master key from the CDMA2000 encryption key using a pseudorandom function. The input to the pseudorandom function should include the CDMA2000 encryption key (SMEKEY), a CDMA2000 subscription identity (M-ID), and a WLAN subscription identity (W-ID) if it is different from the CDMA2000 subscription identity. It may also include a version number (Version-ID), a counter (Counter), as well as other information. Here, without loss of generality, we assume a pseudorandom function with a 128 bit output value and use it as the master key. In the following equation, notation “|” implies concatenation.
MK(Master Key)=PRF_{—}MK(SMEKEY|M-ID|W-ID|Version-ID|Counter| . . . ).
where the pseudorandom function PRF_MK (x) used to derive the key can be any standard specified pseudorandom function.

In step 550 the WLAN authentication server computes a response to authenticate itself to the WLAN device by responding to the random challenge RANDreq. As an example, the response Auth-server is computed as
Auth-server=H(MK|RANDreq|Nouce_{—}4| . . . ).
where the hash function H(x) used to compute the response can be any standard specified one-way hash function. The variable MK is the master key, and Nounce_{—}4 is a public variable such as system time, counter number, or publicly shared random number.

In step 560, the WLAN server generates a random challenge RANDch and sends it to the WLAN device. The WLAN device then use the random challenge (RANDch) together with its master key (MK) and potentially public variables (Nounce_X) such as system times, counter numbers, or publicly shared random numbers, to compute an authentication response (Auth-Res).
Auth-Res=H(MK|RANDch|Nouce_{—}1| . . . ).
The WLAN server will verify the response by computing Auth-Res with the master key and comparing it with the received one. The hash function H(x) used to compute the response can be any standard specified one-way hash function.

In step 570, the WLAN server derives an encryption key (Cipher-key), an integrity protection key (MAC-key), and other keys using pseudorandom functions from the master key. Following are examples for computing an encryption key and an integrity key.
Cipher-key=PRF_{—}c(MK|RANDch|RANDreq|Nouce_{—}2| . . . ),
MAC-Key=PRF_{—}mac(MK|RANDch|RANDreq|Nouce_{—}3| . . . ).

The pseudorandom functions PRF(x) used to derive the keys can be any standard specified pseudorandom functions. For example, they can be essentially the same function with different parameters.

FIG. 6 is a flowchart 600 showing details of WLAN network authentication of a WLAN device using a derived WLAN master key. This flowchart 600 is a subset of the authentication process shown in FIG. 2. Notice that the WLAN network authentication process does not require any interaction with a CDMA2000 authentication center, because there exists a valid master key for the WLAN device.

In start step 601, we assume that the WLAN server has initiated the WLAN network authentication process which means that there exists a valid master key for the WLAN device. In step 610, the WLAN server retrieves the random challenge RANDreq received in an earlier stage and computes a response. In step 620, it generates a random challenge RANDch and sends it to the WLAN device preferably together with the response to RANDreq computed in step 610. In step 630, the WLAN device receives a response from the WLAN device to the random challenge RANDch. Steps 620 and 630 are included in step 237 of FIG. 2. In step 238 (shown here and also in FIG. 2), the WLAN server verifies the WLAN device's response to the random challenge RANDch using the master key. If it is a valid response as determined in step 239, then the WLAN server derives the session keys in step 240. Otherwise, step 250 sends an “authentication failed” message to the WLAN device and the protocol ends in step 699. This flowchart 600 highlights a situation where the WLAN network does not need to communicate with CDMA2000 authentication center—regardless of whether SSD sharing is allowed or not allowed.

The WLAN network authentication procedure shown in FIG. 6 is more frequently conducted than a full authentication with the CDMA2000 network shown in FIG. 2 Therefore, the network traffic will be significantly reduced by using such a master key.

FIG. 7 is a flowchart 700 showing a WLAN device authentication process in a WLAN device according to a preferred embodiment. This authentication process uses CDMA2000 credentials to authenticate to a WLAN network such as the one shown in FIG. 1. This authentication process preferably is implemented as a computer program in a WLAN device with a UIM such as the WLAN wireless communication device 130 with CDMA2000 credentials 110 shown in FIG. 1.

Step 701 starts the WLAN device authentication process at the WLAN device. The start step 701 is initiated by a WLAN device when requesting access to a WLAN network as described previously with reference to FIG. 1. Additionally, the start step 701 can be initiated by the WLAN network requesting re-authentication of the WLAN device as described previously with reference to FIG. 1. Generally, a WLAN network will re-authenticate WLAN devices and/or update the master key periodically as determined by the network operator. Preferably, all communications to and from the WLAN device are in accordance with the EAP/CDMA2000 protocol.

Upon initiating the authentication process, the WLAN device generates a random challenge RANDreq in step 703. Then it sends the challenge to the WLAN network in step 706. If the WLAN server has a valid master key, the flow will skip to step 785, which starts a WLAN network authentication. If the WLAN server does not have a valid master key for this WLAN device, then a full authentication occurs starting with step 710. See decision step 210 in FIG. 2 and accompanying text. The WLAN device receives a CDMA2000 global challenge from the WLAN network in step 710. Using its CDMA2000 credentials 110 shown in FIG. 1, the WLAN device formulates a response to the global challenge in step 720. The WLAN device then sends the response to the WLAN network in step 730. If the response to the global challenge is valid, the WLAN device receives a CDMA2000 unique challenge in step 740. Using its CDMA2000 credentials in the UIM of the WLAN device, the WLAN device formulates a response to the CDMA2000 unique challenge in step 750. Then in step 760, it sends the response to the CDMA2000 unique challenge to the WLAN network.

If the response to the CDMA2000 unique challenge is valid, the WLAN device will receive a “success” message in step 765 and the WLAN device generates a CDMA2000 encryption key in step 770. Preferably, the WLAN network encryption key is a signal encryption key (SMEKEY) that is conventionally generated from CDMA2000 credentials for signal encryption in a CDMA2000 network. In this situation, however, the SMEKEY is re-deployed for use as WLAN key material to generate a master key. From the encryption key, the WLAN device derives a master key in step 780 as previously described with reference to FIG. 2. Upon generating a master key, the WLAN device will receive a WLAN authentication challenge RANDch in step 785, and this message may also include a response to the random challenge RANDreq sent in step 706. The WLAN device uses the master key to verify the response to RANDreq from the network in step 789. If it is valid, then it uses the master key to calculate a response corresponding to the WLAN challenge RANDch in step 790. The response is sent to the WLAN network in step 795.

Using the master key, the WLAN device derives session keys in step 797 similar to the process previously described with reference to step 240 of FIG. 2. Upon authentication of WLAN device and generation of the session keys, the WLAN device authentication process ends in step 799, and the session keys can be used to protect communications between the WLAN access point and the WLAN device.

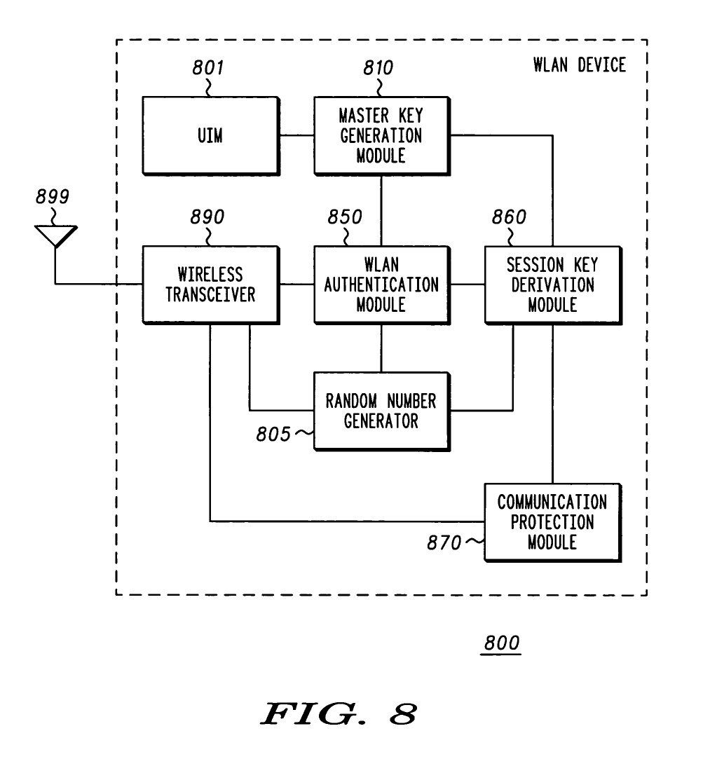

FIG. 8 is a functional block diagram of a WLAN device 800 according to a preferred embodiment. The WLAN device 800 generates a CDMA2000 encryption key, authenticates WLAN networks, and encrypts WLAN data. The WLAN device 800 has an antenna 899 and transceiver 890 for wireless communication.

In a CDMA2000 user identification module (UIM) 801, the CDMA2000 UIM generates and outputs a CDMA2000 encryption key, such as a SMEKEY. The UIM can be either a permanently installed UIM or a removable UIM (R-UIM). The WLAN device then generates a WLAN master key in a master key generation module 810, which is coupled to the UIM and receives the CDMA2000 encryption key and uses it as a basis for master key generation. A random number generator 805, coupled to the transceiver 890, WLAN authentication module 850, and session key derivation module 860, generates random challenge RANDreq. A WLAN authentication module 850, coupled to the master key generation module 810 and the transceiver 890, receives a challenge RANDch from the WLAN network and a network response to a previously generated challenge RANDreq, and it verifies the response to the previously generated challenge RANDreq from the WLAN network using its master key. If the response is valid, the WLAN authentication module 850 calculates a response to the WLAN challenge RANDch using the master key. The WLAN authentication module 850 then sends the response to the random challenge RANDch to the transceiver 890.

After the challenge and response is successfully performed, the session key derivation module 860, which is coupled to the WLAN authentication module 850 and the master key generation module 810, derives session keys from the master key. Communication protection module 870, which is coupled to the session key derivation module 860 and the transceiver 890, uses the session keys in data protection algorithms for communication protection.

Preferably, the modules are implemented as software running in a processor of the WLAN device and are directly or indirectly connected to the transceiver.

FIG. 9 is a flowchart 900 showing a process for converting CDMA2000 authentication protocol to a new extension of Extensible Authentication Protocol (EAP), called EAP/CDMA2000. Preferably a WLAN server such as the WLAN AAA server 150 shown in FIG. 1 performs this conversion process. The protocol is executed between a WLAN network and a WLAN device with CDMA credentials. The main messages of EAP are “request”, “response”, and “success” or “failure”. After the server sends a request message to the device, the device replies with a response message. A success or failure message indicates a successful or failed authentication. EAP/CDMA2000 enables a full authentication with both CDMA2000 global and unique challenges. It may also enable authentication using a valid WLAN master key with neither a global challenge nor a unique challenge but only the WLAN challenge and response.

EAP/CDMA2000 conversion starts in step 901. The WLAN server sends an EAP-request/identity in step 905. It then receives an EAP-response/identity and verifies it in step 910. Steps 905 and 910 are variants of known messages used in many EAP extensions.

In step 915, the WLAN server sends an EAP-request/CDMA2000/start message. The WLAN device recognizes the message as a new extension of EAP using CDMA credentials. The WLAN server receives an EAP-response/CDMA2000/start message from the WLAN device in step 920. The EAP-response/CDMA2000/start message may include embedded data RANDreq. RANDreq is a challenge from the WLAN device which the WLAN server saves for future use as described previously with reference to FIG. 6, step 610.

In step 925, the WLAN server generates a global challenge as specified in CDMA2000 and embeds the global challenge in an EAP-request/CDMA2000/Global message, before sending it. Then the WLAN server receives an EAP-response/CDMA2000/Global message in step 930. The WLAN server then fetches the response to the Global challenge from the message and verifies it. When SSD is not shared, verification will most likely require communication with a CDMA2000 authentication center. When SSD is shared, the WLAN server can verify without interacting with the CDMA2000 authentication center. This is shown and described with reference to FIG. 3. In step 935, if the response to the global challenge is not valid, step 980 sends an EAP failure message.

If the response to the global challenge is valid according to step 935, the WLAN server generates a CDMA2000 unique challenge by itself or receives a CDMA2000 unique challenge from a CDMA2000 authentication center in step 940. In either case, the CDMA2000 unique challenge is inserted to an EAP-request/CDMA2000/Unique message and sent. The WLAN server receives an EAP-response/CDMA2000/Unique message in step 945. The WLAN server fetches the response from the message and verifies it in accordance with FIG. 4 and the accompanying text. Preferably, the CDMA2000 authentication center is involved when SSD is not shared and the CDMA2000 authentication center is not involved when SSD is shared. If step 950 determines it is not a valid response, then the WLAN server sends an EAP failure message in step 980.

If step 950 determines the response is valid, in step 955 the WLAN server generates a random challenge RANDch, embeds it in an EAP-request/CDMA2000/Challenge message, and sends it. The message includes a response from the WLAN server to the challenge RANDreq received and saved in step 920. In step 965, the WLAN server receives an EAP-response/CDMA2000/Challenge message. The WLAN server fetches the response from the message and verifies it. If step 970 determines the response is valid, then the WLAN server sends an EAP success message and derives session keys in step 975. Otherwise, the WLAN server sends an EAP failure message in step 980. The method ends in step 999.

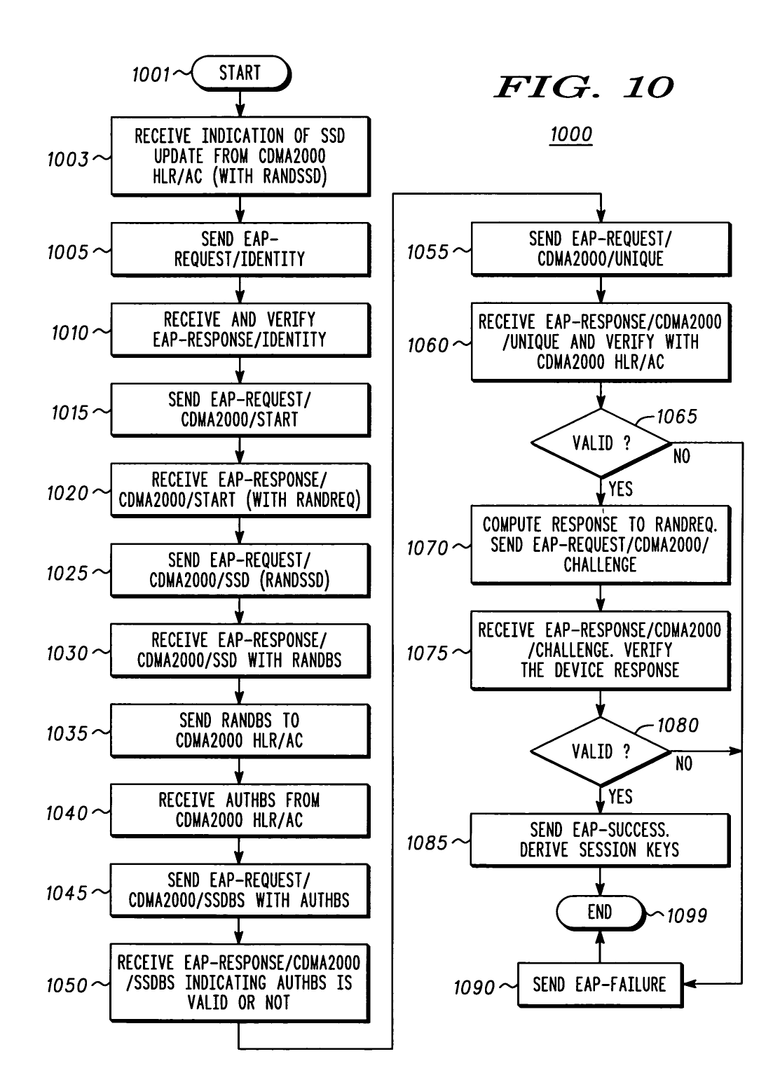

FIG. 10 is a flowchart showing a process 1000 for a shared secret data (SSD) update with a WLAN server converting an SSD update protocol to a new extension of Extensible Authentication Protocol (EAP) called EAP/CDMA2000. An SSD update is usually initiated by a CDMA2000 authentication center. A WLAN server executes an SSD update with a WLAN device to comply with a security policy of the CDMA2000 network and to maintain the interface with the CDMA2000 authentication center. After the process starts in step 1001, the protocol is generally triggered by a message from a CDMA2000 authentication center indicating an SSD update in step 1003. In step 1003, the WLAN server receives a random number RANDSSD for an SSD update.

The WLAN server then sends an EAP-request/identity message in step 1005. It receives an EAP-response/identity message and verifies it in step 1010. Steps 1005 and 1010 are messages common to all EAP extensions.

In step 1015, the WLAN server sends an EAP-request/CDMA2000/start message. The device recognizes the execution is an extension of EAP using CDMA credentials. The WLAN server receives an EAP-response/CDMA2000/start message in step 1020. The EAP-response/CDMA2000/start message may include data RANDreq. RANDreq is a challenge from the WLAN device. The WLAN server saves the RANDreq.

The SSD update is indicated by sending an EAP-request/CDMA2000/SSD message in step 1025. The random number RANDSSD received in step 1003 from the CDMA2000 authentication center is included in the EAP-request/CDMA2000/SSD message. The RANDSSD will be used to compute a new SSD at the device. The EAP-response/CDMA/SSD message received in step 1030 includes a random challenge RANDBS. This is a challenge from the device to the CDMA2000 network.

If the new SSD is not shared, then the WLAN server sends the random challenge RANDBS to the CDMA2000 authentication center in step 1035 and requests a response. It receives a response AUTHBS in step 1040 from the CDMA2000 authentication center. If the new SSD is shared, then steps 1035 and 1040 will be skipped. Instead, the WLAN server computes the response AUTHBS.

The response AUTHBS is included in an EAP-request/CDMA2000/SSDBS message and sent in step 1045. The received EAP-Response/CDMA2000/SSDBS message indicates a validation or invalidation of the response AUTHBS in step 1050.

The WLAN server may generate a CDMA2000 unique challenge itself or receive a CDMA2000 unique challenge from CDMA2000 authentication center in step 1050. In either case, the CDMA2000 unique challenge is inserted to an EAP-request/CDMA2000/Unique message and the message is sent in step 1055. In step 1060, the WLAN server receives an EAP-response/CDMA2000/Unique message. The WLAN server fetches the response from the message and verifies in accordance with FIG. 4 and the accompanying text. Preferably verification occurs with the CDMA2000 authentication center when the new SSD is not shared and verification is autonomous when the new SSD is shared. If step 1065 determines the response is not valid, the WLAN server sends an EAP failure message in step 1090 and the process ends in step 1099.

If the response is valid, in step 1070, the WLAN server generates a random challenge RANDch, embeds it in an EAP-request/CDMA2000/Challenge message and sends it. The message includes a response from the WLAN server to the challenge RANDreq received and saved in step 1020. In step 1075, the WLAN server receives an EAP-response/CDMA2000/Challenge message. The WLAN server fetches the response from the message and verifies it. If step 1080 determines the response to the random challenge is valid, then the WLAN server sends an EAP success message and derives session keys in step 1085 before successfully completing an SSD update in step 1099. Otherwise, the WLAN server sends an EAP failure message in step 1090 before the process ends in step 1099.

Note that the WLAN authentication process employs CDMA2000 device authentication only to the stage that a CDMA2000 encryption key is generated and a master key is formed in the device. This approach relieves the network from frequent interactions between the WLAN network and the CDMA2000 network. An advantage to this approach is that because a WLAN authentication server preferably converts the EAP/CDMA2000 protocol to an ANSI-41 protocol when communicating with the CDMA2000 authentication center, and conversely converts the ANSI-41 protocol to EAP/CDMA2000 protocol when communicating with the WLAN device, the WLAN device authentication process integrates easily into existing WLAN networks and CDMA2000 networks.

Thus, the system, method, and devices for authentication in a WLAN provide a system, method, and devices for using CDMA2000 credentials to authenticate WLAN devices. This process minimizes disruption of existing authentication processes for CDMA2000 and for WLAN and does not greatly increase network traffic. This process does not require any changes to the CDMA2000 credentials or the CDMA2000 authentication center.

While this disclosure includes what are considered presently to be the preferred embodiments and best modes of the invention described in a manner that establishes possession thereof by the inventors and that enables those of ordinary skill in the art to make and use the invention, it will be understood and appreciated that there are many equivalents to the preferred embodiments disclosed herein and that modifications and variations may be made without departing from the scope and spirit of the invention, which are to be limited not by the preferred embodiments but by the appended claims, including any amendments made during the pendency(?) of this application and all equivalents of those claims as issued.

The terms “a” or “an,” as used herein, are defined as one or more than one. The term “plurality,” as used herein, is defined as two or more than two. The term “another,” as used here, is defined as at least a second or more. The terms “including,” “comprising,” and/or “having,” as used herein, are defined as a non-exclusive inclusion (i.e., open language). The term “coupled,” as used herein, is defined as connected, although not necessarily directly and not necessarily mechanically.

The term “program”, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a shared library/dynamic load library and/or other sequence of instructions designed for execution on a computer system.

It is further understood that the use of relational terms such as first and second, top and bottom, and the like, if any, are used solely to distinguish one from another entity, item, or action without necessarily requiring or implying any actual such relationship or order between such entities, items or actions. Much of the inventive functionality and many of the inventive principles are best implemented with or in software programs or instructions. It is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation. Therefore, further discussion of such software, if any, will be limited in the interest of brevity and minimization of any risk of obscuring the principles and concepts according to the present invention.

1. A system comprising:
a CDMA2000 authentication center, for authenticating CDMA2000 credentials;
a wireless local area network (WLAN) authentication server, coupled to the CDMA2000 authentication center, for using CDMA2000 credentials to authenticate WLAN devices holding CDMA2000 credentials; and
at least one WLAN device holding CDMA2000 credentials, coupled to the WLAN authentication server.

2. A system in accordance with claim 1, further comprising:
a WLAN access point, coupled to the WLAN authentication server and wirelessly coupled to the at least one WLAN device holding CDMA2000 credentials.

3. A system according to claim 1, wherein the WLAN authentication server communicates with the CDMA2000 authentication center using an ANSI-41 protocol.

4. A system according to claim 1, wherein the WLAN authentication server communicates with the at least one WLAN device holding CDMA2000 credentials using an extension of Extensible Authentication Protocol (EAP).

5. A method for a wireless local access network (WLAN) server to authenticate a WLAN device using CDMA2000 credentials, comprising the steps of:
performing a CDMA2000 global challenge and response with the WLAN device;
verifying the CDMA2000 global challenge and response;
performing a CDMA2000 unique challenge and response with the WLAN device;
verifying the CDMA2000 unique challenge and response; and
obtaining a CDMA2000 encryption key.

6. A method according to claim 5, wherein the CDMA2000 encryption key is a signal encryption key.

7. A method according to claim 5, further comprising the step of:
deriving a master key from the CDMA2000 encryption key.

8. A method according to claim 7, further comprising the steps of:
performing a WLAN challenge and response with the WLAN device;
verifying the WLAN challenge and response; and
deriving session keys from the master key.

9. A method in accordance with claim 8, wherein the step of performing a WLAN challenge and response with the WLAN device comprises the steps of:
receiving a random challenge RANDreq from the WLAN device;
formatting a response to the random challenge RANDreq;
generating a random challenge RANDch;
sending the random challenge RANDch to the WLAN device;
sending the response to the random challenge RANDreq to the WLAN device; and
receiving a response to the random challenge RANDch from the WLAN device.

10. A method in accordance with claim 8, further comprising the step of:
using the session keys to protect communications between the WLAN and the WLAN device.

11. A method in accordance with claim 5, wherein the step of verifying the global challenge and response comprises the steps of:
determining if a CDMA2000 authentication center shares shared secret data (SSD) with the WLAN server;
sending the global challenge and response to the CDMA2000 authentication center, if the CDMA2000 authentication center does not share SSD with the WLAN server; and
receiving a response from the CDMA2000 authentication center, if the CDMA2000 authentication center does not share SSD with the WLAN server.

12. A method in accordance with claim 5, wherein the step of verifying the CDMA2000 global challenge and response comprises the steps of:
determining if a CDMA2000 authentication center shares shared secret data (SSD) with the WLAN server; and
verifying the global challenge and response autonomously, if the CDMA2000 authentication center does share SSD with the WLAN server.

13. A method in accordance with claim 5, wherein the step of performing a CDMA2000 unique challenge and response comprises the steps of:
determining if a CDMA2000 authentication center shares shared secret data (SSD) with the WLAN server;
receiving a unique challenge and response from the CDMA2000 authentication center, if the CDMA2000 authentication center does not share SSD with the WLAN server;
sending the unique challenge to the WLAN device;
receiving a response to the unique challenge from the WLAN device; and
comparing the response from the WLAN device to the response from the CDMA2000 authentication center.

14. A method in accordance with claim 5, wherein the step of performing a unique challenge and response comprises the steps of:
determining if a CDMA2000 authentication center shares shared secret data (SSD) with the WLAN server;
generating a unique challenge, if the CDMA2000 authentication center does share SSD with the WLAN server;
sending the unique challenge to the WLAN device;
receiving a response to the unique challenge from the WLAN device; and
verifying the response from the WLAN device.

15. A method for a wireless local access network (WLAN) server to authenticate a WLAN device using CDMA2000 credentials comprising the steps of:
determining if the WLAN server has a valid master key for the WLAN device;
performing a WLAN challenge and response with the WLAN device, if there is a valid master key for the WLAN device;
verifying the WLAN challenge and response; and
deriving session keys from the master key.

16. A method in accordance with claim 15, further comprising the step of:
using the session keys to protect communications between the WLAN and the WLAN device.

17. A method in accordance with claim 15, wherein the WLAN server does not communicate with a CDMA2000 authentication center.

18. A method in accordance with claim 15, further comprising the steps of:
performing a global challenge and response with the WLAN device, if there is not a valid master key for the WLAN device;
verifying the global challenge and response;
performing a unique challenge and response with the WLAN device; and
verifying the unique challenge and response.

19. A method in accordance with claim 18, wherein the step of performing a global challenge and response with the WLAN device comprises the steps of:
obtaining the global challenge;
inserting the global challenge into an extension of Extensible Authentication Protocol (EAP) request message;
sending the EAP request message;
receiving an EAP response message; and
fetching a response to the global challenge from the EAP response message.

20. A method in accordance with claim 18, wherein the step of performing a unique challenge and response with the WLAN device comprises the steps of:
obtaining the unique challenge;
inserting the unique challenge into an extension of Extensible Authentication Protocol (EAP) request message;
sending the EAP request message;
receiving an EAP response message; and
fetching a response to the unique challenge from the EAP response message.

21. A method in accordance with claim 18, further comprising the steps of:
obtaining a CDMA2000 encryption key;
deriving a master key from the CDMA2000 encryption key;
performing a WLAN challenge and response with the WLAN device; and
verifying the WLAN challenge and response.

22. A method in accordance with claim 21, wherein the step of performing a WLAN challenge and response with the WLAN device comprises the steps of:
generating a WLAN challenge;
inserting the WLAN challenge into an extension of Extensible Authentication Protocol (EAP) request message;
sending the EAP request message;
receiving an EAP response message; and
fetching a response to the WLAN challenge from the EAP response message.

23. A method in accordance with claim 21, further comprising the steps of:
deriving session keys from the master key; and
using the session keys to protect communications between the WLAN and the WLAN device.

24. A method in accordance with claim 15, wherein there is not a valid master key for the WLAN device when the WLAN server initiates an update to the master key.

25. A method in accordance with claim 15, wherein the WLAN server authenticates the WLAN device using an extension of Extensible Authentication Protocol (EAP).

26. A method for a wireless local access network (WLAN) server to update shared secret data (SSD) in a WLAN device using CDMA2000 credentials, comprising the steps of:
receiving an SSD update request from a CDMA2000 authentication center;
performing an SSD update with the WLAN device;
obtaining a CDMA2000 encryption key;
deriving a master key from the CDMA2000 encryption key;
performing a WLAN challenge and response with the WLAN device;
verifying the WLAN challenge and response; and
deriving session keys from the master key.

27. A method in accordance with claim 26, wherein the WLAN server performs the SSD update with the WLAN device using an extension of Extensible Authentication Protocol (EAP).

28. A wireless local area network (WLAN) device having a wireless transceiver comprising:
a CDMA2000 user identifier module (UIM), for storing CDMA2000 credentials and generating a CDMA2000 encryption key;
a random number generator, coupled to the wireless transceiver, for generating a random challenge;
a master key generation module, coupled to the UIM, for deriving a WLAN master key from the CDMA2000 encryption key;
a WLAN authentication module, coupled to the random number generator, the master key generation module, and the wireless transceiver, for responding to a challenge from a WLAN server;
a session key derivation module, coupled to the random number generator, the WLAN authentication module, and the master key generation module, to derive session keys from the master key; and
a communication protection module, coupled to the session key derivation module and the wireless transceiver, to apply protection to WLAN data using the session keys.

29. A method according to claim 28, wherein the CDMA2000 encryption key is a signal encryption key.

30. A method for a wireless local access network (WLAN) device using CDMA2000 credentials to authenticate with a WLAN server, comprising the steps of:
receiving a global challenge from the WLAN server;
formulating a response to the global challenge;
sending the global challenge to the WLAN server;
receiving a unique challenge from the WLAN server;
formulating a response to the unique challenge;
sending the unique challenge to the WLAN server;
generating a CDMA2000 encryption key; and
deriving a master key from the CDMA2000 encryption key.

31. A method according to claim 30, further comprising the steps of:
receiving a WLAN challenge from the WLAN server;
formulating a response to the WLAN challenge;
sending the response to the WLAN server; and
deriving session keys from the master key.

32. A method in accordance with claim 31, further comprising the step of:
using the session keys to protect communications between the WLAN and the WLAN device.

33. A method in accordance with claim 30, further comprising the steps of:
generating a random challenge and sending the random challenge to the WLAN server.

34. A method in accordance with claim 33, further comprising the step of:
receiving a response to the random challenge from the WLAN server; and
verifying the response to the random challenge.
